(19) United States
(12) Patent Application Publication
(10) Pub. No.: US 2025/0061326 A1
(43) Pub. Date: Feb. 20, 2025

(54) METHOD FOR REDUCING COMPUTATIONAL COST FOR AUTONOMOUS DRIVING SYSTEM

(71) Applicant: AUTOBRAINS TECHNOLOGIES LTD., Tel Aviv -Yafo (IL)

(72) Inventors: Julius Engelsoy, Tel Aviv-Yafo (IL); Igal Raichelgauz, Tel Aviv (IL); Armin Biess, Ness Ziona (IL); Adam Harel, Neve YavaV (IL); Isaac Misri, Tel Aviv-Yafo (IL); Joey Hendry, Tel Aviv-Yafo (IL)

(73) Assignee: AUTOBRAINS TECHNOLOGIES LTD., Tel Aviv -Yafo (IL)

(21) Appl. No.: 18/451,118

(22) Filed: Aug. 17, 2023

(51) Int. Cl. G06N 3/08; B60W 60/00

(52) U.S. Cl. CPC G06N 3/08; B60W 60/001; B60W 2420/403; B60W 2420/408; B60W 2556/45

(57) ABSTRACT

A method for reducing the computational cost for an autonomous driving system is disclosed. The method may include the following steps: a) acquiring data related to a task for operating a vehicle; b) training a deep learning model using the data acquired, wherein the deep learning model includes an encoder and a policy head for the task; c) reducing a complexity of the data acquired in step a) by passing the data to the encoder to produce a compressed latent representation of the data; and d) determining a driving operation by the policy head using the compressed latent representation of the data.

### FIELD OF DISCLOSURE

The present disclosure relates to the field of computer technology, and more particularly, to a method and/or an apparatus for reducing the computational cost for an autonomous driving system.

### BACKGROUND

As computing and vehicular technologies continue to evolve, autonomy-related features have become more powerful and widely available, and capable of controlling vehicles in a wider variety of circumstances. For automobiles, for example, the Society of Automotive Engineers (SAE) has established a standard (J3016) that identifies six levels of driving automation from “no automation” to “full automation”. The SAE standard defines Level 0 as “no automation” with full-time performance by the human driver of all aspects of the dynamic driving task, even when enhanced by warning or intervention systems. Level 1 is defined as “driver assistance”, where a vehicle controls steering or acceleration/deceleration (but not both) in at least some driving modes, leaving the operator to perform all remaining aspects of the dynamic driving task. Level 2 is defined as “partial automation”, where the vehicle controls steering and acceleration/deceleration in at least some driving modes, leaving the operator to perform all remaining aspects of the dynamic driving task. Level 3 is defined as “conditional automation”, where, for at least some driving modes, the automated driving system performs all aspects of the dynamic driving task, with the expectation that the human driver will respond appropriately to a request to intervene. Level 4 is defined as “high automation”, where, for only certain conditions, the automated driving system performs all aspects of the dynamic driving task even if a human driver does not respond appropriately to a request to intervene. The certain conditions for Level 4 can be, for example, certain types of roads (e.g., highways) and/or certain geographic areas (e.g., a geofenced metropolitan area which has been adequately mapped). Finally, Level 5 is defined as “full automation”, where a vehicle is capable of operating without operator input under all conditions.

A fundamental challenge of any autonomy-related technology relates to collecting and interpreting information about a vehicle's surrounding environment, along with planning and executing commands to appropriately control vehicle motion to safely navigate the vehicle through its current environment. Therefore, continuing efforts are being made to improve each of these aspects, and by doing so, autonomous vehicles increasingly are able to reliably operate in increasingly complex environments and accommodate both expected and unexpected interactions within an environment. For example, to operate safely, autonomous vehicles should account for objects-such as vehicles, people, trees, animals, buildings, signs, and poles-when planning paths through the environment.

As the autonomous driving system needs to continuously monitor its surroundings, the amount of information to be processed is huge. Thus, it is important to develop algorithms that reduce the computational complexity yet maintain the agility and safety of the automated driving operations.

### SUMMARY

An object of the present disclosure is to propose a method and/or an apparatus for reducing the computational cost for an autonomous driving system. To do so, this invention discloses various end-to-end deep learning models for an autonomous driving vehicle control system. The end-to-end deep learning models accept raw data from various sensors, e.g., camera, LIDAR, etc. The raw data can be collected directly from the sensors of the vehicle subject to be controlled. The raw data can also be sensory data recorded, e.g., recorded driving, from any vehicle or shared by another vehicle in real time. The end-to-end deep learning models produce driving control decisions as outputs. Moreover, the deep learning model approach can use data that is not manually annotated and is thus much more reasonable (e.g., less expensive) to acquire and more abundant.

Specifically, a mid-level compressed or reduced dimensional latent representation of the raw data may be provided for using/training an autonomous driving system to output driving control decisions, for example, in data-scarce cases such as reinforcement learning. Various embodiments disclose encoders that transform the raw data to compressed latent representations. Compressed latent representations is significantly reduced in terms of the amount of data compared to the raw data. This allows the computational efficiency of the end-to-end deep learning model for an autonomous driving system to be increased in both training and/or using modes. In one example, the encoder extracts useful features from the raw data for a specific driving task, e.g., lane centering, lane changing, traffic sign reading, etc., and disregards the rest of the data. In another example, the feature extraction by the encoder can be done by various machine visual recognitions, curve fitting, pattern recognition, text recognition, etc.

In other embodiments, a mask can be employed to further sparsify the compressed latent representation. This further reduced the data amount to be processed and increases the computational efficiency.

In some embodiments, a method for reducing the computational cost for an autonomous driving system is disclosed. The method includes a) acquiring data related to a task for operating a vehicle; b) training a deep learning model using the data acquired, wherein the deep learning model includes an encoder and a policy head for the task; c) reducing a complexity of the data acquired in step a) by passing the data to the encoder to produce a compressed latent representation of the data; and d) determining a driving operation by the policy head using the compressed latent representation of the data.

In some embodiments, the data acquired includes recorded human driving data from a same or a separate vehicle. In some embodiments, the data acquired includes artificially augmented data. In some embodiments, the data is acquired using a sensor of a same or a separate vehicle, and the sensor includes one or more lidar sensors, radar sensors, infrared sensors, and/or image sensors.

In some embodiments, the step c) further includes applying a mask that is element-wise multiplied by the compressed latent representation to further reduce the complexity of the data. In such embodiments, the step c) further includes comprising normalizing mask values.

In some embodiments, the method further includes applying a loss function to evaluate a difference between the driving operation determined by the policy head and a driving operation benchmark.

In some embodiments, the method further includes configuring one or more overlapping elements of the compressed latent representation produced by a first encoder of a first deep learning model, such that the compressed latent representation is configured to be shareable by a second encoder of a second deep learning model.

In some embodiments, another method for reducing the computational cost for an autonomous driving system is disclosed. The method includes a) acquiring data related to a task for operating a vehicle; b) operating a deep learning model with the data acquired, wherein the deep learning model includes a policy head for the task; c) obtaining a compressed latent representation of the data acquired in step a); and d) determining a driving operation by the policy head using the compressed latent representation of the data.

In some embodiments, another method for reducing the computational cost for an autonomous driving system is disclosed. The method includes a) acquiring data related to a task for operating a vehicle; b) training a first deep learning model using the data acquired, wherein the first deep learning model includes a first encoder and a policy head; c) identifying one or more overlapping elements between the data related to the task and a compressed latent representation related to another task, wherein the compressed latent representation is produced by a second deep learning model with a second encoder, the compressed latent representation is configured to be shareable with the first encoder of the first deep learning model; and d) determining a driving operation by the policy head using the compressed latent representation produced by the second deep learning model with the second encoder.

In some embodiments, the disclosed method may be operated by an apparatus of an autonomous driving system. The apparatus may include at least one processor and a memory storing instructions. The instructions when executed by the at least one processor cause the at least one processor to perform operations of the disclosed method for reducing the computational cost for an autonomous driving system. For example, in some embodiments, the disclosed method may be programmed as computer executable instructions stored in non-transitory computer readable medium. The non-transitory computer readable medium, when loaded to a computer, directs a processor of the computer to execute the disclosed method. The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF DRAWINGS

To illustrate the embodiments of the present disclosure or related art more clearly, the following figures will be described in the embodiments are briefly introduced. It is obvious that the drawings are merely some embodiments of the present disclosure, a person having ordinary skill in this field may obtain other figures according to these figures without paying the premise. The arrows in the figures indicate a relationship whereby the component the arrow is pointing to is trained/applied using the component the arrow is pointing from. The embodiments of the disclosure will be understood and appreciated more fully from the following detailed description, taken in conjunction with the drawings in which:

FIG. 1 is a block diagram illustrating an example implementation of a deep learning model in training or in use, in accordance with some embodiments of the present disclosure;

FIG. 2 is a block diagram illustrating another example implementation of a deep learning model in training or in use with a mask function, in accordance with some embodiments of the present disclosure;

FIG. 3 is a block diagram illustrating an example implementation of a plurality of deep learning models in training or in use with a mask function, in accordance with some embodiments of the present disclosure;

FIG. 4 is a table illustrating an example of identifying one or more overlapping elements related to different tasks, in accordance with some embodiments of the present disclosure;

FIG. 5 is a flowchart illustrating an example of operations of an end-to-end deep learning model in training, in accordance with some embodiments of the present disclosure;

FIG. 6 is a flowchart illustrating an example of operations of an end-to-end deep learning model in use, in accordance with some embodiments of the present disclosure;

FIG. 7 is a flowchart illustrating an example of operations of the plurality of the deep learning models in training, in accordance with some embodiments of the present disclosure;

FIG. 8 is an illustration of an example of operating an autonomous driving system without a mask function, in accordance with some embodiments of the present disclosure;

FIG. 9 is an illustration of an example of operating an autonomous driving system with a mask function for a lane centering/keeping task, in accordance with some embodiments of the present disclosure;

FIG. 10 is an illustration of an example of operating an autonomous driving system with a mask function for a traffic sign reading task, in accordance with some embodiments of the present disclosure; and

FIG. 11 illustrates an example hardware and software environment for an autonomous vehicle, in accordance with some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure. In the following detailed description, numerous specific details are set forth to provide a thorough understanding of the invention. However, it will be understood by those skilled in the art that the present invention may be practiced without these specific details. In other instances, well-known methods, procedures, and components have not been described in detail so as not to obscure the present invention. The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention. For example, the specification and/or drawings may refer to a processor or to a processing circuitry. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The following specification and/or drawings may refer to an image. An image is an example of a media unit. Any reference to an image may be applied mutatis mutandis to a media unit. A media unit may be an example of a sensed information unit (SIU). Any reference to a media unit may be applied mutatis mutandis to any type of natural signal such as but not limited to signal generated by nature, signal representing human behavior, signal representing operations related to the vehicle signals, geodetic signals, geophysical signals, textual signals, numerical signals, time series signals, and the like. Any reference to a media unit may be applied mutatis mutandis to the SIU. The SIU may be of any kind and may be sensed by any type of sensors-such as a visual light camera, an audio sensor, a sensor that may sense infrared, radar imagery, ultrasound, electro-optics, radiography, Lidar (light detection and ranging), a thermal sensor, a passive sensor, an active sensor, etc. The sensing may include generating samples (e.g., pixel, audio signals, etc.) that represent the signal that is transmitted, or otherwise reach the sensor. The SIU may have one or more images, one or more video clips, textual information regarding the one or more images, text describing kinematic information, and the like.

Any combination of any module or unit listed in any of the figures, any part of the specification and/or any claims may be provided. Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like. The vehicle may be any type of vehicle—for example a ground transportation vehicle, an airborne vehicle, or a water vessel. The vehicle is also referred to as an ego-vehicle. It should be understood that the autonomous driving includes at least partially autonomous (semi-autonomous) driving of a vehicle, which includes all the L2 level types or higher defined in the SAE standard.

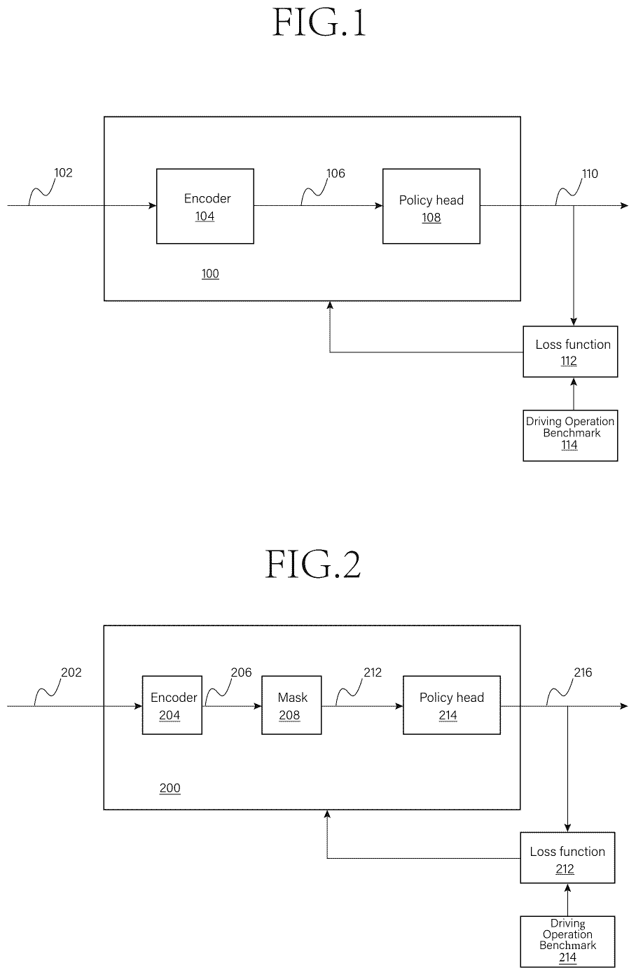

Now referring to the drawings, wherein like numbers denote like parts throughout the several views, FIGS. 1-3 are block diagrams illustrating different end-to-end deep learning models that execute methods for reducing the computational cost for a system, including but not limited to, an autonomous driving, in accordance with some embodiments of the present disclosure. The model may have a computer system for training and/or operating one or more models, which may be artificial intelligence (AI) models including but not limited to deep learning models, such as a deep neural network with one or more latent layers/representations. It should be understood that these and other arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory. It should be understood that the deep learning models described below may be neural networks including a plurality of layers such as input layers, latent/hidden layers, and output layers. Each of the neural network layers may include a plurality of nodes (or neurons), which are connected, typically in series.

In some embodiments, FIG. 1 is a block diagram of a deep learning model 100 including an encoder 104 and a policy head 108. Each of the encoder 104 and the policy head 108 may be a trainable AI model. In one embodiment, the deep learning model is task specific, e.g., lane centering, lane changing, traffic sign reading, etc. The encoder 104 receives raw data 102 and. The encoder 104 extracts the features from raw data 102, reducing the high dimensional raw data into a low dimensional latent vector as a compressed latent representation 106 accordingly. In such a manner, the data volume/complexity of the raw data 102 may be reduced by forming the compressed latent representation 106. The compressed latent representation 106 of the raw data 102 helps to learn the data characteristics and simplify data representations. The encoder 104 outputs the compressed latent representation 106 to the policy head 108. The policy head 108 receives the compressed latent representation 106 and outputs a driving operation decision 110 accordingly. In different embodiments, the compressed latent representation 106 may be obtained by dropping duplicated or not-valuable data and/or using different data representation and approximation techniques, i.e., transferring fewer data without losses and transferring compact models instead of raw data. For example, in some embodiments, the compressed latent representation 106 may apply linear or non-linear transformations to the raw data 102 for generating the output driving operation decision 110.

In some embodiments, the raw data 102 is raw data from one or more sensors of a same or a separate vehicle. For example, the raw data 102 may be an image captured by a camera sensor that includes Red-Green-Blue (RGB) value of pixels. The raw data 102 may be a raw SIU, a processed SIU, text information, information derived from the SIU, and the like. In different embodiments, the loading of the raw data 102 may be from a local disk, over a suitable network location, from a remote storage location, etc. Obtaining of the raw data 102 may include receiving the data, generating the data, participating in a processing of the data, processing only a part of the data and/or receiving only another part of the data. The processing of the data 102 may include at least one out of detection, noise reduction, improvement of signal to noise ratio, defining bounding boxes, and the like. The raw data 102 may be received from one or more sources such as one or more sensors, one or more communication units, one or more memory units, one or more image processors, and the like.

In some embodiments, the encoder 104 may be configured to map the raw data 102 into the compressed latent representation 106 which may be stored in a database of semantic relations. In some embodiments, the encoder 104 learns the input data dimension compression to encode the features' latent representation, whereas the policy head 108 recreates the encoded latent representation to a reconstructed output such as the output driving operation decision 110. For example, the encoder 104 may be configured to generate compressed latent representation 106 of the raw data 102 with a one-dimensional vector, representing one or more elements of the raw data 102. In one embodiment, the compressed latent representation may be expressed as a vector V, wherein V=[E₁, E₂, E₃, . . . . E_{N}], E₁ means element 1, E₂ means element 2, E₃ means element 3, E_{N} means element N. Each element may be a single or plural dimensional matrix. Each element may represent a potentially useful feature of the surroundings of the vehicle, such as lane borderlines, lane centerline, vehicles nearby, traffic signs, tree contours, etc. See FIG. 4 for example.

The encoder 104 may be configured to encode meaningful information about various data attributes in its latent manifold which can then be exploited to carry out pertinent tasks. In such embodiments, the compressed latent representation 106 helps to reduce the dimensionality of the input data and to eliminate non-relevant information. Thus, the dimensionality reduction of the input date would reduce computational consumption and help to avoid overfitting.

In some embodiments, given the compressed latent representation 106, the policy head 108 may be configured to determine the behavior that a vehicle needs to follow from a set of predefined tasks. The tasks determine the actions that an autonomous car needs to take based on the compressed latent representation 106. Some examples of these tasks are lane keeping, overtaking another car, changing lanes, intersection handling, and traffic light handling, among others.

In some embodiments, a gradient of a loss function 112 may be configured to evaluate a difference between the driving operation decision 110 determined by the policy head 108 and a driving operation benchmark 114 to characterize an accuracy of the compressed latent representations 106. A loss function is a measure of how well a prediction model does in terms of being able to predict an expected outcome. The parameters of the encoder 104 and/or the compressed latent representations 106 may be updated/adjusted based on the gradient of the loss function 112 to achieve improved driving decision outputs. It should be understood that the loss function 112 may not be needed when the model is only for operation without training purposes. However, the operation and training of the system may be conducted simultaneously.

In some other embodiments, as shown in FIG. 2, a deep learning model 200 may include the similar structures as the deep learning model 100, and further include a trainable mask 208 to further reduce the computational cost by further reducing the complexity of the input data. The trainable mask 208 may be configured to generate a sparse latent representation 212 based on a compressed latent representation 206 for a policy head 214 to generate a driving operation decision 216.

For example, in some embodiments, the trainable mask 208 may be element-wise multiplied by the compressed latent representation 206 generated by an encoder 204 based on a set of raw data 202. In one embodiment, the trainable mask 208 can be a vector that has elements that match the compressed latent representation 206. The trainable mask 208 may zero out or normalize the less useful elements in the compressed latent representation 206 to further sparsify the data.

For example, in a model 200 that deals with the task of lane changing, the mask 208 may keep the elements of the compressed latent representation 206 of lane borderline [E1], lane centerline [E2], other vehicles [E3], traffic sign text [E4], but zeros out tree contour [E5], because the model 200 determines tree contour is less useful for the task of lane changing. Thus, in this embodiment, if the compressed latent representation is vector V=[E1, E2, E3, E4, E5], than the sparse latent representation 212 is a vector Vₛₚₐᵣₛₑ=[E1, E2, E3, E4, 0], wherein “0” means zero matrix.

In some embodiments, the trainable mask 208 may be configured to map from the compressed latent representation 206 to generate the sparse latent representation 212 received by the policy head 214 to determine the output driving operation decision 216. For example, the mask value of the trainable mask 208 may be normalized to lie between zero and one (e.g., passing trainable parameters to sigmoid functions) to encourage data sparsity. In some embodiments, a loss function 212 may be configured to compare the output of the policy head 216 with a driving operation benchmark 214. The mask values may be added to the loss function 212 in the form of an L1 regularization loss, which adds up the absolute values of the mask elements thereby leading to many of the mask values of the trainable mask 208 being set to zero for a better data sparsity of the sparse latent representation 212. It should be understood that the loss function 212 may be applied to the encoder 204 and/or the mask 208 to improve system performance.

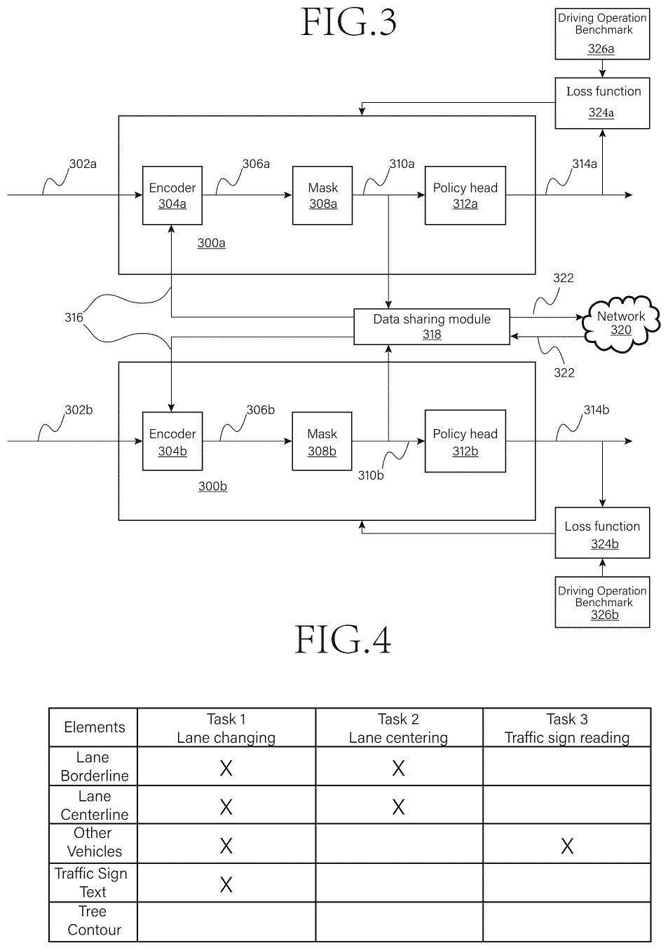

In some embodiments, the compressed latent representation may be configured to be shareable among a plurality of end-to-end deep learning models. For example, as shown in FIG. 3, two deep learning models 300a and 330b in training are illustrated. The deep learning model 300a includes an encoder 304a and a policy head 312a. In some embodiments, a trainable mask 308a may be element-wise multiplied by a compressed latent representation 306a generated by the encoder 304a based on a set of raw data 302a. In such embodiments, the trainable mask 308a may be configured to map from the compressed latent representation 306a to generate a sparse latent representation 310a for receiving by the policy head 312a to determine the output driving operation decision 314a. In some embodiments, a gradient of a loss function 324a may be configured to evaluate a difference between the driving operation decision 314a determined by the policy head 312a and a driving operation benchmark 326a to characterize an accuracy of the compressed latent representations 306a and/or the sparse latent representation 310a. The loss function 324a may be applied to the encoder 304a, the mask 308a, or the policy head 312a to improve system performance.

A deep learning model 300b includes the same structures as the deep learning model 300a. In some embodiments, a data sharing module 318 may be configured to identify one or more overlapping elements between the data and the sparse latent representations 310a, 310b of the deep learning models 300a and 300b, such that one or more sparse latent representations 310a, 310b are configured to be shareable by the encoders 304a and 304b of the two deep learning models. The shared latent representation further increases the computational efficiency of the autonomous driving system.

In one embodiment, the deep learning model 300a is for lane changing, and 300b for lane centering. The data sharing module 308 may compare the elements of the sparse latent representations 310a and 310b. The sparse latent representation 310a for lane changing may include elements of lane borderline, lane centerline, other vehicles, and traffic sign text. The sparse latent representation 310b for lane centering may include elements of lane borderline and lane centerline. The data sharing module 318 determines the overlapping elements of 310a and 310b, e.g., lane borderline and lane centerline. The data sharing module 318 then creates the shared latent representation 316 and sends it to the encoder 304a, 304b, or any other encoders that may need such overlapping elements. The data sharing module 318 may also upload or download 322 of the overlapping elements to/from the network 320. The storage of the one or more elements of the compressed latent representation over the network 320 facilitates further sharing among deep learning models at different time points.

The sharing capability may be configured to optimize the trainable latent representations and mask functions. To better illustrate the sharable compressed/sparse latent representation feature, FIG. 4 is a table illustrating an example of identifying one or more overlapping elements related to different tasks, such as tasks of lane changing (Task 1), lane centering (Task 2), and traffic sign reading (Task 3). As shown here, both the tasks of lane changing and lane centering require the elements regarding the lane borderline and lane centerline to accomplish the task. Thus, in some embodiments the overlapping elements, e.g., lane borderline and lane centerline, of a sparse latent representation 310 can be shared from one to another deep learning model 300 by the data sharing module 318.

In some embodiments, a sparse latent representation 310 already configured for one task may be provided and applied directly for another task for a same or different vehicle by the data sharing module 318. In such an overlapping element-sharing manner, computational cost is further reduced as the system receiving the sharable elements may not need to generate its own compressed or sparse latent representation. In some embodiments, the sharing of the elements may be performed via network 320, including but not limited to a Wi-Fi, a DSRC connection, etc. The data sharing may also be extended beyond autonomous vehicles to autonomous drones, autonomous transport robots, or any other systems capable of autonomous navigation via a machine learning model.

In some embodiments, one or more networks 320 (e.g., a LAN, a WAN, a wireless network, and/or the Internet, among others) may be provided to permit the communication of information with other data sharing modules 318, computers and/or electronic devices, including, for example, a central service, such as a cloud service, from which the data sharing module 318 receives sharable compressed/sparse latent representations, environmental and other data for use in autonomous control thereof. For example, in some embodiments, one or more predefined latent representations 316 are configured to be sharable by the data sharing module 318 and the network 320. In such embodiments, the shared latent representation 316 configured by a local model may be uploaded 322 to and stored in the network 320 (e.g., a cloud system) for use by other models in remote, and the data sharing module 318 may also download 322 the shared latent representation 316 from the network 320 for use locally. In different embodiments, the data sharing module 318 may be a tangible or intangible entity, for example, an entity that is physically constructed, specifically configured (e.g., hardwired), or configured (e.g., programmed) to operate in a specified manner or to perform part or all of any operation described herein. The data sharing may be for one type of data or multiple types of data, for a one-time use, multiple use and/or persistent use. The data shared can be collected and distributed in originally uploaded form or can be further processed before sharing. The data shared can be transmitted in real-time or near real time.

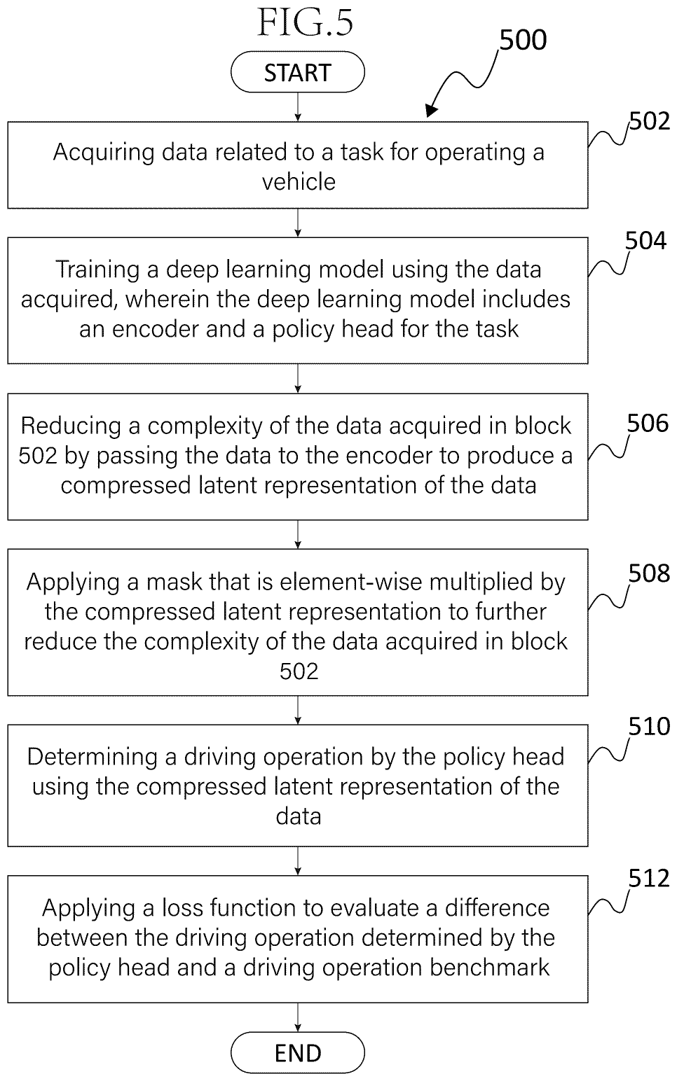

Now turning to FIGS. 5-7, these figures illustrate three methods 500, 600, and 700 corresponding to the models as discussed above that may be used to reduce the computational cost. It is noted that the sequence of the methods 500, 600, and 700 is exemplary and indicates no order of the steps that the methods 500, 600, 700 to be performed. As shown in FIG. 5, the methods of operation 500 may start by acquiring data related to a task (e.g., lane changing, lane centering, traffic sign reading, etc.) for operating a vehicle in block 502 and training a deep learning model using the data acquired in block 504. As discussed above, the deep learning model may include an encoder and a policy head for the task. Then, in block 506, a complexity of the data acquired in block 502 may be reduced by passing the data to the encoder to produce a compressed latent representation of the data, and a driving operation may be determined by the policy head using the compressed latent representation of the data in block 510.

In some embodiments, the data acquired in block 502 may include recorded human driving data from a same or a separate vehicle and may be from one or more sensors. For example, in some embodiments, the data acquired may be from a storage/memory including the recorded human driving data. In some embodiments, the recorded human driving data may be vehicle data logs from completed driving sessions of regular vehicles, driving simulation systems, or autonomous vehicles. For example, an autonomous vehicle or associated computing system may collect and store human driving and/or vehicle data as the autonomous vehicle executes a driving session. After the session has been completed, a log of the recorded data may be transferred to a computing system, such as a cloud system, for training or using the autonomous driving systems as described above.

In some embodiments, to collect and label enough data to train the models as discussed above that control the vehicle's behavior, different types of sensors, such as lidar sensors, radar sensors, infrared sensors, and/or image sensors, may be utilized to generate data that capture various aspects of the driving environment. However, not all data are equally useful or available for training the model. Some data may be noisy, incomplete, or imbalanced. To overcome these limitations, in some embodiments, the data acquired in block 502 for training the model may be processed as artificially augmented data. Data augmentation techniques can enhance the quality and diversity of the data by applying transformations such as cropping, flipping, rotating, scaling, adding noise, changing brightness, interpolating, 3-D model creating or blending images. These techniques can help the model learn more robust and generalizable features that improve its performance and accuracy. For example, certain elements (e.g., animals, adverse weather conditions, traffic lights, etc.) may be introduced into the input data to improve the training outcome.

In some embodiments, to further reduce the computational cost, the methods of operation 500 may further include a block 508 of applying a mask that is element-wise multiplied by the compressed latent representation to further reduce the complexity of the data acquired in block 502. In some embodiments, the mask values of the mask may be normalized as discussed previously. In some other embodiments, the methods of operation 500 may further include applying a loss function to evaluate a difference between the driving operation determined by the policy head and a driving operation benchmark as described previously to improve system performance in block 512.

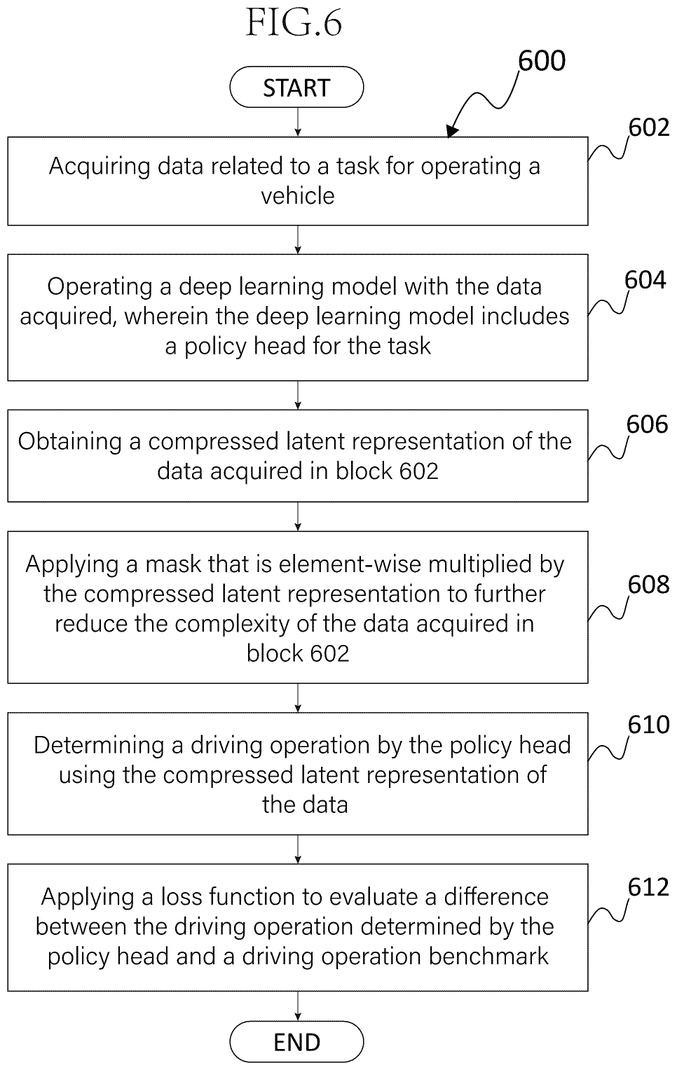

In some embodiments, as shown in FIG. 6, the method of 600 illustrates the operation of applying an already trained model. The method of 600 may start by acquiring data related to a task (e.g., lane changing, lane centering, traffic sign reading, etc.) for operating a vehicle in block 610 and operating a deep learning model using the data acquired in block 602. The deep learning model may include a policy head for the task. Then, a compressed latent representation is obtained for application in block 606. In one example, at 606, the obtaining can be using the encoder to extract useful features from the raw data. In another example, at 606, the obtaining can be downloading the latent compressed representation from network or any nonvolatile electronic storage medium. With the compressed latent representation, a driving operation may be determined by the policy head in block 610. Similar to the methods of operation 500, the methods of operation 600 may also include a block 608 of applying a mask that is element-wise multiplied by the compressed latent representation to further reduce the complexity of the data acquired and a block 612 of applying a loss function to evaluate a difference between the driving operation determined by the policy head and a driving operation benchmark as described previously to improve system performance.

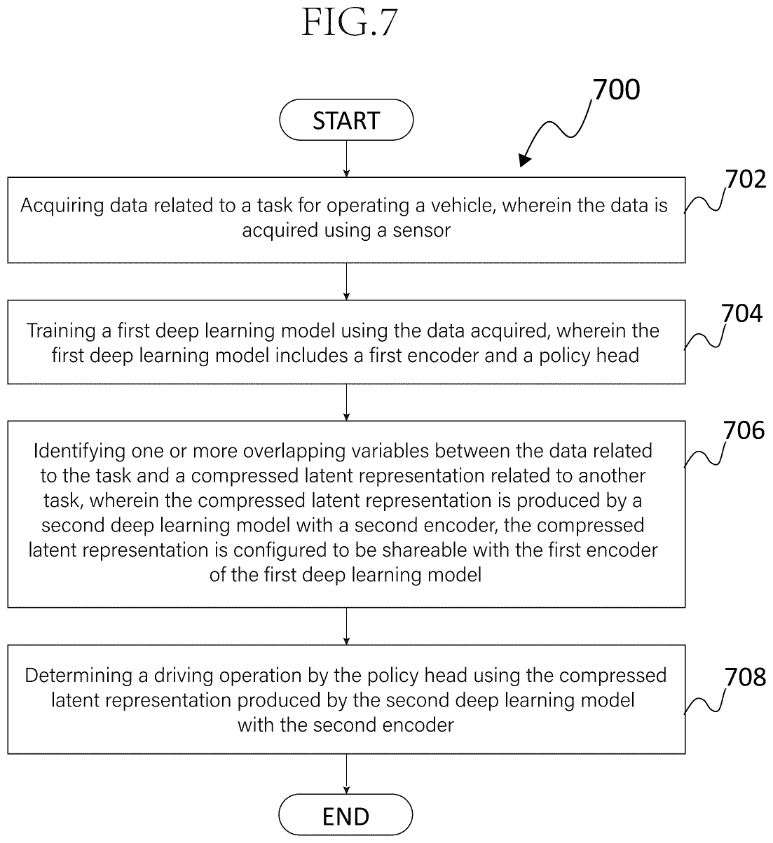

In some embodiments, a compressed latent representation may be configured to be shareable between a plurality of deep learning models. For example, as shown in FIG. 7, the methods of operation 700 may include the similar first two steps as the methods of operation 500: acquiring data related to a task for operating a vehicle in block 702 and training a first deep learning model with a first encoder and a policy head using the data acquired in block 704. The first deep learning model includes a first encoder and a policy head. Then, the operation may continue by identifying one or more overlapping elements between the data related to the task and a compressed latent representation related to another task (as shown in FIGS. 3-4) in block 706, with the compressed latent representation being produced by a second deep learning model with a second encoder. Thus, in such embodiments, the compressed latent representation produced by the second deep learning model with the second encoder is configured to be shareable with the first encoder of the first deep learning model. In block 708, a driving operation is determined by the policy head using the compressed latent representation produced by the second deep learning model with the second encoder. Thus, the computational cost of the first deep learning model is reduced.

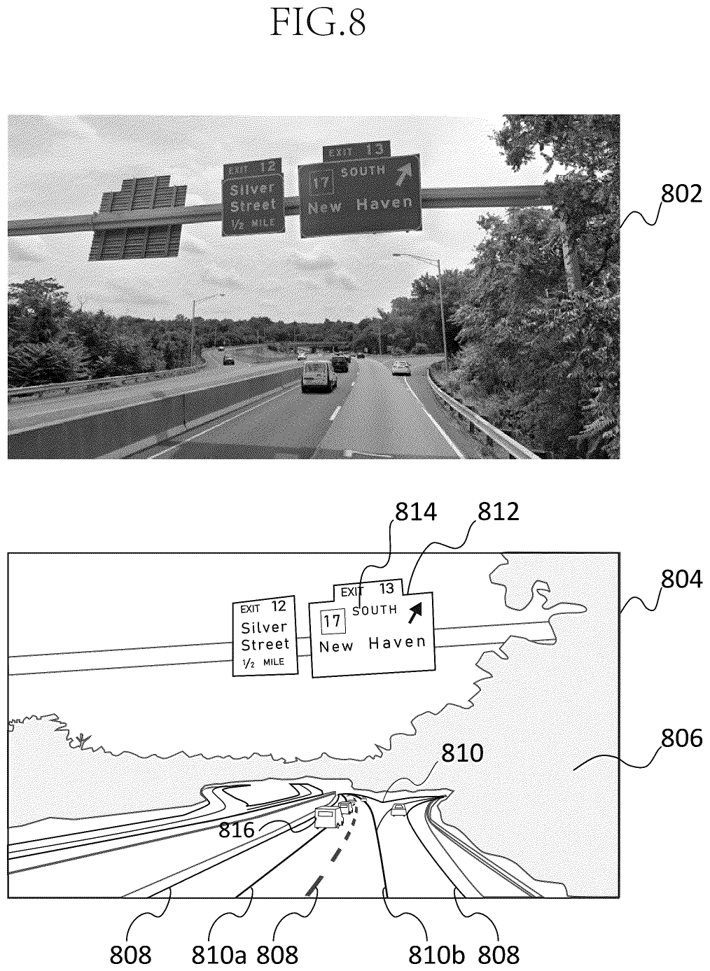

FIGS. 8-10 are different illustrations of different examples of operating an autonomous driving system for different tasks. FIGS. 8-10 show examples of raw data 102, 202, 302, compressed latent representation 106, 206, 306, and sparse latent representation 212, 310 in FIGS. 1-3 where applicable. FIGS. 8-10 show examples of raw data, compressed latent representation, and mask generated data, i.e., sparse latent representation in FIGS. 5-7 where applicable.

As shown in FIGS. 8-10, input images 802, 902, and 1002 may be the raw data from a camera sensor, and the compressed latent representations 804, 904, and 1004 may be compact representations of the input images that capture the useful features generated by an encoder 104, 204, 304. As shown here, the input images may be high dimensional as the raw data, such as RGB images, for surrounding environment of an autonomous vehicle are usually high dimensional. A raw data image not only includes an image of a road, but also includes images of scenes around the road, such as other vehicles, trees, traffic signs, and the sky. By contrast, in some embodiments, the compressed latent representations retain only some areas of interest, and a color image is usually converted into a black/white image. For example, as shown in FIG. 8, the compressed latent representation 804 may be converted from the raw color image 802 as a black/white line image 804, only including a tree contour 806, a lane borderline 808, a first lane centerline 810a, a second lane centerline 810b. a traffic sign contour 812, a traffic sign text 814, and other vehicles 816.

In some embodiments, Gamma correction may be first performed on the input raw image 802 to improve adaptability of the images, and image binarization may then be performed to convert the image from color to black and white. In some embodiments, after image binarization processing, cavities may be repaired by using a morphology operation, a boundary may be smoothed, and then a center line of lanes (e.g., 810a, 810b) may be extracted by using a skeleton extraction algorithm. In some embodiments, local filtering may be performed by using a Hough conversion result to remove interference and glitches. In different embodiments, the lane borderline 808 may be a guard rail, an interface between asphalt and grass, or another indicator of a lane boundary. Although depicted as a single dashed/solid line here, lane markings 808, 810a, and 810b may be a solid line or a double line (such as double solid, solid with dashed), or the like. The purpose of the image downgrading/down-sampling operation is to reduce the dimensions of the image for the compressed latent representation to reduce the computational cost. In such embodiments, the extraction of latent representations from the input images involves obtaining a compact and lower-dimensional representation of an image, which embodies the essential features and patterns contained within the image.

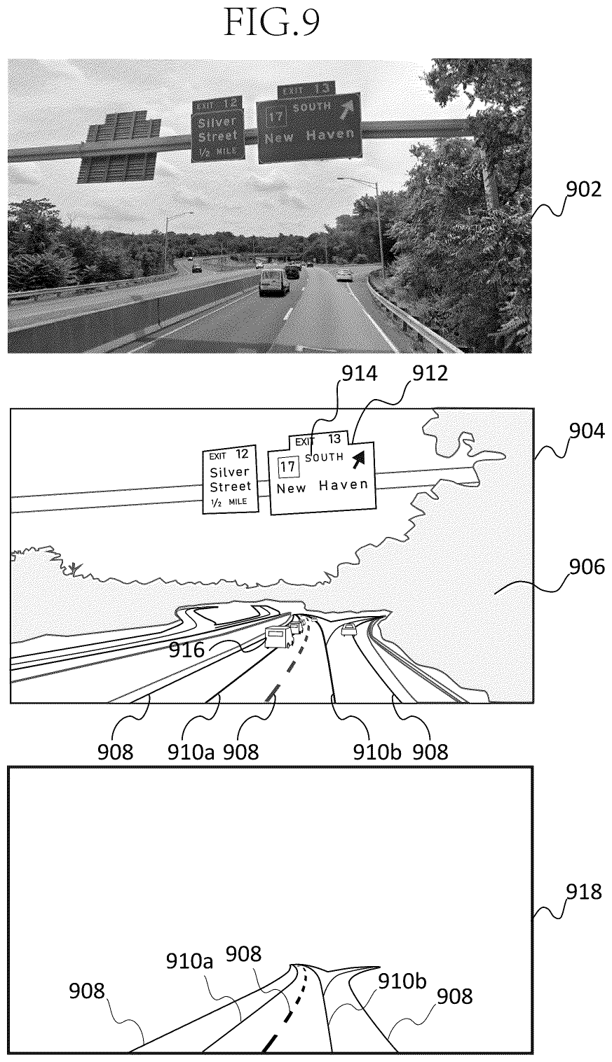

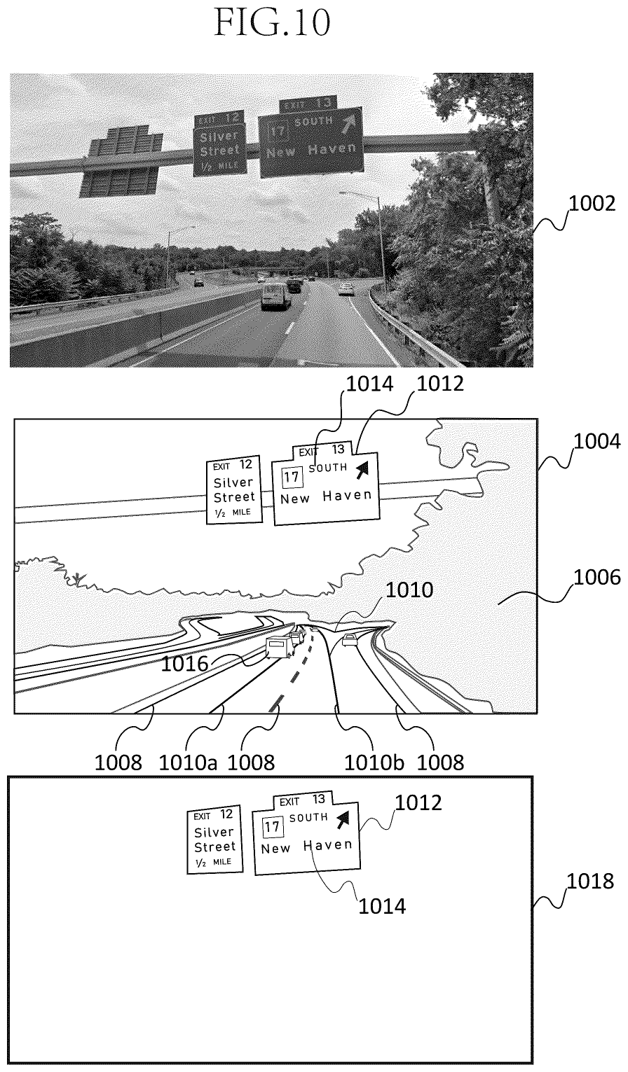

In some embodiments as shown in FIG. 9-10, sparse latent representations 918 and 1018 may be the sparse latent representation 212, 310. Sparse latent representations 918 and 1018 may be further simplified from compressed latent representations 904 and 1004 respectively to provide views with even fewer elements-keeping the only essential elements for the policy head to determine the driving operation decisions according to different tasks. The purpose of the masking operation is to selectively preserve or discard certain pixel values. For example, for the task of lane centering as shown in FIG. 9, only elements regarding lane conditions and other vehicles, such as a lane borderline 908, a first lane center line 910a, a second lane center line 910b, and other moving vehicles 916 are retained in the sparse latent representations 918. Elements that are not useful for the lane centering task, such as a tree contour 906, a traffic sign contour 912, a traffic sign text 914, and other vehicles 916, among other irrelevant elements, are removed from the compressed latent representation image 904 to generate the sparse latent representation image 918 for a better data sparsity. Similarly, for the task of the traffic sign reading, only elements regarding traffic signs, such as a traffic sign contour 1012 and a traffic sign text 1014, are retained in the sparse latent representations 1018 compared with the compressed latent representations 1004 for this specific task.

In some embodiments, the functions/features described above may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be implemented in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, Flash memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

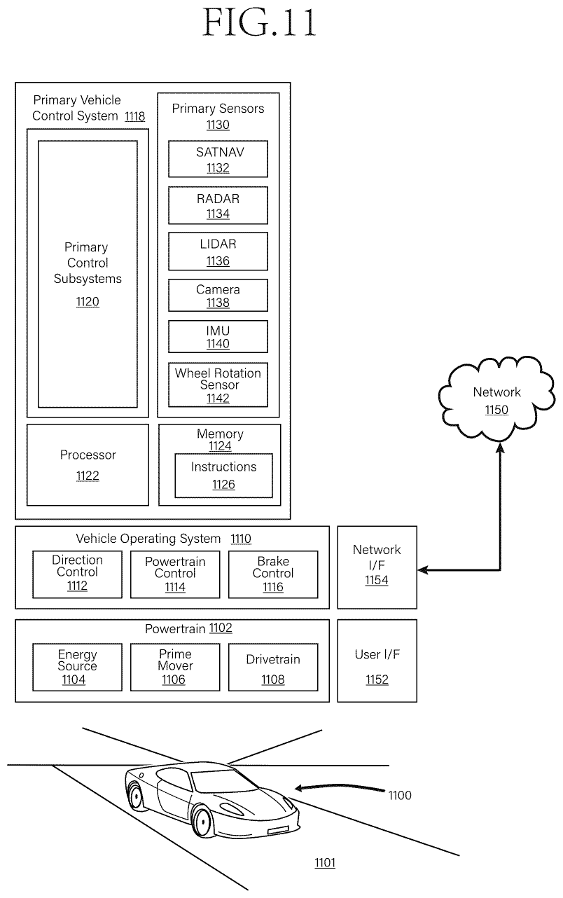

FIG. 11 illustrates an example hardware and software environment for an autonomous vehicle 1000 within which various techniques disclosed herein may be implemented. The vehicle 1100, for example, is shown driving on a road 1101, and the vehicle 1100 may include a powertrain 1102 including a prime mover 1106 powered by an energy source 1104 and capable of providing power to a drivetrain 1108, as well as a vehicle operating system 1110 including a direction control 1112, a powertrain control 1114 and a brake control 1116. The vehicle 1100 may be implemented as any number of different types of vehicles, including vehicles capable of transporting people and/or cargo, and capable of traveling by land, by sea, by air, underground, undersea and/or in space, and it will be appreciated that the aforementioned components 1102-1116 can vary widely based upon the type of vehicle within which these components are utilized.

For simplicity, the embodiments discussed hereinafter will focus on a wheeled land vehicle such as a car, van, truck, bus, etc. In such embodiments, the prime mover 1106 may include one or more electric motors and/or an internal combustion engine (among others). The energy source 1104 may include, for example, a fuel system (e.g., providing gasoline, diesel, hydrogen, etc.), a battery system, solar panels, or other renewable energy source, and/or a fuel cell system. The drivetrain 1108 may include wheels and/or tires along with a transmission and/or any other mechanical drive components suitable for converting the output of the prime mover 1106 into vehicular motion, as well as one or more brakes configured to controllably stop or slow the vehicle 1100 and direction or steering components suitable for controlling the trajectory of the vehicle 1100 (e.g., a rack and pinion steering linkage enabling one or more wheels of the vehicle 100 to pivot about a generally vertical axis to vary an angle of the rotational planes of the wheels relative to the longitudinal axis of the vehicle). In some embodiments, combinations of powertrains and energy sources may be used (e.g., in the case of electric/gas hybrid vehicles), and in other embodiments multiple electric motors (e.g., dedicated to individual wheels or axles) may be used as the prime mover 1106. In the case of a hydrogen fuel cell implementation, the prime mover 1106 may include one or more electric motors and the energy source 1104 may include a fuel cell system powered by hydrogen fuel.

The direction control 1112 may include one or more actuators and/or sensors for controlling and receiving feedback from the direction or steering components to enable the vehicle 1100 to follow a desired trajectory. The powertrain control 1114 may be configured to control the output of the powertrain 1102, e.g., to control the output power of the prime mover 1106, to control a gear of a transmission in the drivetrain 1108, etc., thereby controlling a speed and/or direction of the vehicle 1100. The brake control 1116 may be configured to control one or more brakes that slow or stop the vehicle 1100, e.g., disk or drum brakes coupled to the wheels of the vehicle.

Other vehicle types, including but not limited to all-terrain or tracked vehicles, and construction equipment, may utilize different powertrains, drivetrains, energy sources, direction controls, powertrain controls and brake controls. Moreover, in some embodiments, some of the components can be combined, e.g., where directional control of a vehicle is primarily handled by varying an output of one or more prime movers. Therefore, embodiments disclosed herein are not limited to the particular application of the herein-described techniques in an autonomous, wheeled, land vehicle.

In the illustrated embodiment, full or semi-autonomous control over the vehicle 1100 is implemented in a primary vehicle control system 1118, which may include one or more processors 1122 and one or more memories 1124, with each processor 1122 configured to execute program code instructions 1126 stored in the memory 1124. The processors 1122 may include, for example, graphics processing unit(s) (GPU) and/or central processing unit(s) (CPU). The processors 1122 may also include an application-specific integrated circuit (ASICs), other chipsets, logic circuits and/or data processing devices. The memory 1124 may be used to load and store data and/or instructions, for example, for the control system 1118. The memory 1124 may include any combination of suitable volatile memory, for example, read-only memory (ROM), dynamic random access memory (DRAM), a random access memory (RAM), non-volatile memory such as a flash memory, a memory card, a storage medium and/or other storage devices. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

Sensors 1130 may include various sensors suitable for collecting information from a vehicle's surrounding environment for use in controlling the operation of the vehicle 1100. For example, the sensors 1130 may include one or more detection and ranging sensors (e.g., a RADAR sensor 1134, a LIDAR sensor 1136, or both), a satellite navigation (SATNAV) sensor 1132, e.g., compatible with any of various satellite navigation systems such as GPS (Global Positioning System), GLONASS (Globalnaya Navigazionnaya Sputnikovaya Sistema, or Global Navigation Satellite System), BeiDou Navigation Satellite System (BDS), Galileo, Compass, etc. The Radio Detection And Ranging (RADAR) 1134 and Light Detection and Ranging (LIDAR) sensors 1136, as well as a digital camera 1138 (which may include various types of image capture devices capable of capturing still and/or video imagery), may be used to sense stationary and moving objects within the immediate vicinity of a vehicle. The camera 1138 can be a monographic or stereographic camera and can record still and/or video images. The SATNAV sensor 1132 can be used to determine the location of the vehicle on the Earth using satellite signals. The sensors 1130 can optionally include an inertial measurement unit (IMU) 1140. The IMU 1140 may include multiple gyroscopes and accelerometers capable of detecting linear and rotational motion of the vehicle 1100 in three directions. One or more other types of sensors, such as wheel rotation sensors/encoders 1142 may be used to monitor the rotation of one or more wheels of vehicle 1100.

In a variety of embodiments, a removable hardware pod is vehicle agnostic and therefore can be mounted on a variety of non-autonomous vehicles including: a car, a bus, a van, a truck, a moped, a tractor trailer, a sports utility vehicle, etc. While autonomous vehicles generally contain a full sensor suite, in many embodiments a removable hardware pod can contain a specialized sensor suite, often with fewer sensors than a full autonomous vehicle sensor suite, which can include: an IMU, 3D positioning sensors, one or more cameras, a LIDAR unit, etc. Additionally or alternatively, the hardware pod can collect data from the non-autonomous vehicle itself, for example, by integrating with the vehicle's CAN bus to collect a variety of vehicle data including: vehicle speed data, braking data, steering control data, etc. In some embodiments, removable hardware pods can include a computing device which can aggregate data collected by the removable pod sensor suite as well as vehicle data collected from the CAN bus, and upload the collected data to a computing system for further processing (e.g., uploading the data to the cloud). In many embodiments, the computing device in the removable pod can apply a time stamp to each instance of data prior to uploading the data for further processing. Additionally or alternatively, one or more sensors within the removable hardware pod can apply a time stamp to data as it is collected (e.g., a lidar unit can provide its own time stamp). Similarly, a computing device within an autonomous vehicle can apply a time stamp to data collected by the autonomous vehicle's sensor suite, and the time stamped autonomous vehicle data can be uploaded to the computer system for additional processing.

The outputs of sensors 1130 may be provided to a set of primary control subsystems 1120, including, for example, a localization subsystem, a perception subsystem, a planning subsystem, and a control subsystem. The localization subsystem is principally responsible for precisely determining the location and orientation (also sometimes referred to as “pose” or “pose estimation”) of the vehicle 1100 within its surrounding environment, and generally within some frame of reference. In some embodiments, the pose is stored within the memory 1124 as localization data. In some embodiments, a surface model is generated from a high-definition map, and stored within the memory 1124 as surface model data. In some embodiments, the detection and ranging sensors store their sensor data in the memory 1124, e.g., radar data point cloud is stored as radar data. In some embodiments, calibration data is stored in the memory 1124. The perception subsystem is principally responsible for detecting, tracking, and/or identifying objects within the environment surrounding vehicle 1100. A machine learning model, such as the one discussed above in accordance with some embodiments, can be utilized in planning a vehicle trajectory. The control subsystem 1120 is principally responsible for generating suitable control signals for controlling the various controls in the vehicle control system 1118 in order to implement the planned trajectory of the vehicle 1100. Similarly, a machine learning model can be utilized to generate one or more signals to control the autonomous vehicle 1100 to implement the planned trajectory.

It will be appreciated that the collection of components illustrated in FIG. 11 for the vehicle control system 1118 is merely one example. Individual sensors may be omitted in some embodiments. Additionally, or alternatively, in some embodiments, multiple sensors of the same types illustrated in FIG. 11 may be used for redundancy and/or to cover different regions around a vehicle. Moreover, there may be additional sensors of other types beyond those described above to provide actual sensor data related to the operation and environment of the wheeled land vehicle. Likewise, different types and/or combinations of control subsystems may be used in other embodiments. Further, while the primary control subsystems 1120 is illustrated as being separate from the processor 1122 and memory 1124, it will be appreciated that in some embodiments, some or all of the functionality of the primary control subsystems 1120 may be implemented with program code instructions 1126 resident in one or more memories 1124 and executed by one or more processors 1122, and the primary control subsystems 1120 may in some instances be implemented using the same processor(s) and/or memory. Subsystems may be implemented at least in part using various dedicated circuit logic, various processors, various field programmable gate arrays (FPGA), various application-specific integrated circuits (ASIC), various real time controllers, and the like, as noted above, multiple subsystems may utilize circuitry, processors, sensors, and/or other components. Further, the various components in the vehicle control system 1118 may be networked in various manners.

For example, the vehicle 1100 may include one or more network interfaces, e.g., network interface 1154, suitable for communicating with one or more networks 1150 (e.g., a LAN, a WAN, a wireless network, and/or the Internet, among others) to permit the communication of information with other vehicles, computers and/or electronic devices, including, for example, a central service, such as a cloud service, from which the vehicle 1100 receives environmental and other data for use in autonomous control thereof.

In addition, for additional storage, the vehicle 1100 may also include one or more mass storage devices, e.g., a floppy or other removable disk drive, a hard disk drive, a direct access storage device (DASD), an optical drive (e.g., a CD drive, a DVD drive, etc.), a solid state storage drive (SSD), network attached storage, a storage area network, and/or a tape drive, among others. Furthermore, the vehicle 1100 may include a user interface 1152 to enable the vehicle 1100 to receive a number of inputs from and generate outputs for a user or operator, e.g., one or more displays, touchscreens, voice and/or gesture interfaces, buttons and other tactile controls, etc. Otherwise, user input may be received via another computer or electronic device, e.g., via an app on a mobile device or via a web interface, e.g., from a remote operator.

Systems and methods are disclosed herein related to object detection and detection confidence. Disclosed approaches may be suitable for autonomous driving, but may also be used for other applications, such as robotics, video analysis, weather forecasting, medical imaging, etc. The present disclosure may be described with respect to an example autonomous vehicle 1100. Although the present disclosure primarily provides examples using autonomous vehicles, other types of devices may be used to implement those various approaches described herein, such as robots, camera systems, weather forecasting devices, medical imaging devices, etc. In addition, these approaches may be used for controlling autonomous vehicles, or for other purposes, such as, without limitation, video surveillance, video or image editing, video or image search or retrieval, object tracking, weather forecasting (e.g., using radar data), and/or medical imaging (e.g., using ultrasound or magnetic resonance imaging (MRI) data).

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

If the software function unit is realized and used and sold as a product, it may be stored in a readable storage medium in a computer. Based on this understanding, the technical plan proposed by the present disclosure may be essentially or partially realized as the form of a software product. Or one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a ROM, a RAM, a floppy disk, or other kinds of media capable of storing program codes. While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by people skilled in the art that the embodiments of the disclosure are not limited by what has been particularly shown and described hereinabove. Rather the scope of the embodiments of the disclosure is defined by the appended claims and equivalents thereof.

The previous description of the disclosed embodiments is provided to enable others to make or use the disclosed subject matter. Various modifications to these embodiments will be readily apparent, and the generic principles defined herein may be applied to other embodiments without departing from the spirit or scope of the previous description. Thus, the previous description is not intended to be limited to the embodiments shown herein but is to be accorded the widest scope consistent with the principles and novel features disclosed herein. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.” It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order and are not meant to be limited to the specific order or hierarchy presented.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example. The foregoing method descriptions and the process flow diagrams are provided merely as illustrative examples and are not intended to require or imply that the blocks of various examples must be performed in the order presented. As will be appreciated, the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular. The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. The hardware used to implement the various illustrative logics, logical blocks, modules, and circuits described in connection with the examples disclosed herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

Further Embodiments are listed below.

Embodiment 1. A method for reducing the computational cost for an autonomous driving system, the method comprising: a) acquiring data related to a task for operating a vehicle; b) training a deep learning model using the data acquired, wherein the deep learning model includes an encoder and a policy head for the task; c) reducing a complexity of the data acquired in step a) by passing the data to the encoder to produce a compressed latent representation of the data; and d) determining a driving operation by the policy head using the compressed latent representation of the data.

Embodiment 2. The method of Embodiment 1, wherein the data acquired includes recorded human driving data from a same or a separate vehicle.

Embodiment 3. The method of Embodiments 1-2, wherein the data acquired includes artificially augmented data.

Embodiment 4. The method of Embodiments 1-3, wherein the data is acquired using a sensor of a same or a separate vehicle, the sensor including one or more lidar sensors, radar sensors, infrared sensors, and/or image sensors.

Embodiment 5. The method of Embodiments 1-4, wherein the step c) further includes applying a mask that is element-wise multiplied by the compressed latent representation to further reduce the complexity of the data acquired in step a).

Embodiment 6. The method of Embodiments 5, further comprising normalizing mask values.

Embodiment 7. The method of Embodiments 1-6, further comprising applying a loss function to evaluate a difference between the driving operation determined by the policy head and a driving operation benchmark.

Embodiment 8. The method of Embodiments 1-7, further comprising configuring one or more overlapping elements of the compressed latent representation produced by a first encoder of a first deep learning model, such that the compressed latent representation is configured to be shareable by a second encoder of a second deep learning model.

Embodiment 9. A method for reducing the computational cost for an autonomous driving system, the method comprising: a) acquiring data related to a task for operating a vehicle; b) operating a deep learning model with the data acquired, wherein the deep learning model includes a policy head for the task; c) obtaining a compressed latent representation of the data acquired in step a); and d) determining a driving operation by the policy head using the compressed latent representation of the data.

Embodiment 10. The method of Embodiment 9, wherein the data acquired includes recorded human driving data from a same or a separate vehicle.

Embodiment 11. The method of Embodiments 9-10, wherein the data acquired include artificially augmented data.

Embodiment 12. The method of Embodiments 9-11, wherein the data is acquired using a sensor of a same or a separate vehicle, the sensor including one or more lidar sensors, radar sensors, infrared sensors, and/or image sensors.

Embodiment 13. The method of Embodiments 9-12, wherein the step c) further includes applying a mask that is element-wise multiplied by the compressed latent representation to further reduce the complexity of the data acquired in step a).

Embodiment 14. The method of Embodiments 13, further comprising normalizing mask values.

Embodiment 15. The method of Embodiments 9-14, further comprising applying a loss function to evaluate a difference between the driving operation determined by the policy head and a driving operation benchmark.

Embodiment 16. The method of Embodiments 9-15, further comprising configuring one or more overlapping elements of the compressed latent representation produced by a first encoder of a first deep learning model, such that the compressed latent representation is configured to be shareable by a second encoder of a second deep learning model.

Embodiment 17. A method for reducing the computational cost for an autonomous driving system, the method comprising: a) acquiring data related to a task for operating a vehicle; b) training a first deep learning model using the data acquired, wherein the first deep learning model includes a first encoder and a policy head; c) identifying one or more overlapping elements between the data related to the task and a compressed latent representation related to another task, wherein the compressed latent representation is produced by a second deep learning model with a second encoder, the compressed latent representation is configured to be shareable with the first encoder of the first deep learning model; and d) determining a driving operation by the policy head using the compressed latent representation produced by the second deep learning model with the second encoder.

Embodiment 18. The method of Embodiment 17, wherein the data acquired includes recorded human driving data from a same or a separate vehicle.

Embodiment 19. The method of Embodiments 17-18, wherein the data acquired includes artificially augmented data.

Embodiment 20. The method of Embodiments 17-19, wherein the data is acquired using a sensor of a same or a separate vehicle, the sensor including one or more lidar sensors, radar sensors, infrared sensors, and/or image sensors.

Embodiment 21. An apparatus for operating an autonomous driving system, the apparatus comprising: at least one processor and a memory storing instructions, wherein the instructions when executed by the at least one processor, cause the at least one processor to perform operations, the operations comprising the method of Embodiments 1-20.

Embodiment 22. A non-transitory computer readable storage medium storing computer instructions executable by one or more processors to perform a method for controlling an autonomous driving system and reducing the computational cost associated thereof, the method comprising the Embodiments 1-20.

What is claimed is:

1. A method for reducing the computational cost for an autonomous driving system, the method comprising:
a) acquiring data related to a task for operating a vehicle;
b) training a deep learning model using the data acquired, wherein the deep learning model includes an encoder and a policy head for the task;
c) reducing a complexity of the data acquired in step a) by passing the data to the encoder to produce a compressed latent representation of the data; and
d) determining a driving operation by the policy head using the compressed latent representation of the data.

2. The method of claim 1, wherein the data acquired includes recorded human driving data from a same or a separate vehicle.

3. The method of claim 1, wherein the data acquired includes artificially augmented data.

4. The method of claim 1, wherein the data is acquired using a sensor of a same or a separate vehicle, the sensor including one or more lidar sensors, radar sensors, infrared sensors, and/or image sensors.

5. The method of claim 1, wherein the step c) further includes applying a mask that is element-wise multiplied by the compressed latent representation to further reduce the complexity of the data acquired in step a).

6. The method of claim 5, further comprising normalizing mask values.

7. The method of claim 1, further comprising applying a loss function to evaluate a difference between the driving operation determined by the policy head and a driving operation benchmark.

8. The method of claim 1, further comprising configuring one or more overlapping elements of the compressed latent representation produced by a first encoder of a first deep learning model, such that the compressed latent representation is configured to be shareable by a second encoder of a second deep learning model.

9. A method for reducing the computational cost for an autonomous driving system, the method comprising:
a) acquiring data related to a task for operating a vehicle;
b) operating a deep learning model with the data acquired, wherein the deep learning model includes a policy head for the task;
c) obtaining a compressed latent representation of the data acquired in step a); and
d) determining a driving operation by the policy head using the compressed latent representation of the data.

10. The method of claim 9, wherein the data acquired includes recorded human driving data from a same or a separate vehicle.

11. The method of claim 9, wherein the data acquired include artificially augmented data.

12. The method of claim 9, wherein the data is acquired using a sensor of a same or a separate vehicle, the sensor including one or more lidar sensors, radar sensors, infrared sensors, and/or image sensors.

13. The method of claim 9, wherein the step c) further includes applying a mask that is element-wise multiplied by the compressed latent representation to further reduce the complexity of the data acquired in step a).

14. The method of claim 13, further comprising normalizing mask values.

15. The method of claim 9, further comprising applying a loss function to evaluate a difference between the driving operation determined by the policy head and a driving operation benchmark.

16. The method of claim 9, further comprising configuring one or more overlapping elements of the compressed latent representation produced by a first encoder of a first deep learning model, such that the compressed latent representation is configured to be shareable by a second encoder of a second deep learning model.

17. A method for reducing the computational cost for an autonomous driving system, the method comprising:
a) acquiring data related to a task for operating a vehicle;
b) training a first deep learning model using the data acquired, wherein the first deep learning model includes a first encoder and a policy head;
c) identifying one or more overlapping elements between the data related to the task and a compressed latent representation related to another task, wherein the compressed latent representation is produced by a second deep learning model with a second encoder, the compressed latent representation is configured to be shareable with the first encoder of the first deep learning model; and
d) determining a driving operation by the policy head using the compressed latent representation produced by the second deep learning model with the second encoder.

18. The method of claim 17, wherein the data acquired includes recorded human driving data from a same or a separate vehicle.

19. The method of claim 17, wherein the data acquired includes artificially augmented data.

20. The method of claim 17, wherein the data is acquired using a sensor of a same or a separate vehicle, the sensor including one or more lidar sensors, radar sensors, infrared sensors, and/or image sensors.
